(19) United States
(12) Patent Application Publication
(10) Pub. No.: US 2023/0222875 A1
(43) Pub. Date: Jul. 13, 2023

(54) A GAMING SYSTEM

(71) Applicant: CAMMEGH LIMITED, Ashford (GB)

(72) Inventors: Andrew CAMMEGH, Ashford (GB); Richard CAMMEGH, Ashford (GB)

(73) Assignee: CAMMEGH LIMITED, Ashford (GB)

(21) Appl. No.: 17/927,080

(22) PCT Filed: May 24, 2021
(86) PCT No.: PCT/EP2021/063768

§ 371 Date: Nov. 22, 2022

(30) Foreign Application Priority Data
May 22, 2020 (GB) 2007711.1

(51) Int. Cl. G07F 17/32

(52) U.S. Cl. CPC G07F 17/3267; G07F 17/322; G07F 17/3225; G07F 17/3258

(57) ABSTRACT

A gaming system comprising a roulette wheel including a rotating wheel and a ball which generates a random number; one or more wager receiver to receive wagers placed by one or more players; a plurality of first winning event tokens; and a prize pool server, wherein the prize pool server includes a data receiver to receive details of the wagers placed by the players via the or each wager receiver, a processor for determining a prize pool and a data storage module for storing data relating to the prize pool; wherein if the random number generated by the roulette wheel does not satisfy a predetermined condition a losing event is defined and the monetary value of the wagers placed by the player(s) are added to the prize pool; and if the random number satisfies the pre-determined condition then a winning event is defined and the or each winning player receives one of the first winning event tokens which is used to select a number from an array of numbers that correspond to the numbers of the rotating wheel for a subsequent spin of the roulette wheel, wherein if the random number generated by the roulette wheel on its subsequent spin matches the selected number, a second winning event is defined and the player then wins a portion of the prize pool.

The present invention relates to a gaming system and, in particular to a gaming system based on a roulette wheel.

The game of roulette is well known: a random number is generated based on a ball landing in a numbered pocket of a rotating wheel and players place wagers based on a number, groups of numbers or a property (red/black; odd/even, etc.) associated with one or more numbers.

In a conventional game of roulette, a single random number is generated for each spin of the roulette wheel. Such a game does not provide a suitable basis for what is known as a progressive jackpot, in which a number of losing wagers are placed in a prize pool until such time that a winning event is obtained, at which point, one or more players share the prize pool.

The present invention seeks to provide a gaming system based on a roulette wheel that generates pairs of random numbers based on the physical properties of the mechanical roulette wheel. A progressive jackpot game may be played based on the pair of random numbers that are generated.

According to a first aspect of the invention, there is provided a gaming system comprising a roulette wheel including a rotating wheel and a ball which generates a random number; a wager receiver to receive wagers placed by one or more players; a plurality of first winning event tokens; and a prize pool server, wherein the prize pool server includes a data input interface to receive details of the wagers placed by the players, a processor for determining a prize pool and a data storage module for storing data relating to the prize pool; wherein if the random number generated by the roulette wheel does not satisfy a pre-determined condition a losing event is defined and the monetary value of the wagers placed by the player(s) are added to the prize pool; and if the random number satisfies the pre-determined condition then a winning event is defined and the or each winning player receives one of the first winning event tokens which is used to select a number from an array of numbers that correspond to the numbers of the rotating wheel for a subsequent spin of the roulette wheel, wherein if the random number generated by the roulette wheel on its subsequent spin matches the selected number, a second winning event is defined and the player then wins a portion of the prize pool.

The skilled person will appreciate that a “winning player” is a player who placed a wager on an event via the wager receiver and the event is defined as a winning event. Similarly, a “losing wager” is a wager which is placed on an event (a spin of the roulette wheel), and the event is defined as a losing event.

The invention therefore provides a progressive roulette game.

The subsequent spin of the roulette wheel (i.e. the prize pool portion game) may be based solely on the random number generated by the rotating wheel on the subsequent spin. In other words, it may be based solely on a single subsequent spin of the roulette wheel, wherein if a player has selected the number associated with the pocket in which the ball lands, that player wins the prize pool portion. If no players win the prize pool portion on the subsequent spin of the rotating wheel, the prize pool portion may be retained within the prize pool.

The skilled person will further appreciate that the roulette wheel comprises a standard roulette wheel that includes a rotating wheel having a plurality of numbered pockets located circumferentially around its periphery and a ball that eventually lands in one of the pockets as the speed of rotation of the wheel slows down. Such roulette wheels are well known. The number associated with the pocket in which the ball comes to rest is a randomly generated number from the set of numbers defined by the pockets of the wheel.

The present invention provides a progressive jackpot element which is controlled by the prize pool server. It will be appreciated that the progressive jackpot gambling system may exist alongside a traditional game of roulette. In other words, players may still place bets or wagers (the terms are interchangeable in the context of the present invention) on the first random number generated by the ball landing in a specific numbered pocket of the wheel, in addition to placing wagers via the wager receiver for the gambling system of the present invention.

In an embodiment of the first aspect of the invention, the gaming system further includes a second winning event token, wherein in the event of a second winning event, the player receives the second winning event token which is used to select a number from an array of numbers that correspond to the numbers of the rotating wheel for a further subsequent spin of the roulette wheel, wherein if the random number generated by the roulette wheel on its further subsequent spin matches the number selected with the second winning event token, a third winning event is defined and the player then wins at least a further portion of the prize pool.

In a further embodiment of the first aspect of the invention, the gaming system further includes a third winning event token, wherein in the event of a third winning event, the player receives the third winning event token which is used to select a number from an array of numbers that correspond to the numbers of the rotating wheel for a further subsequent spin of the roulette wheel, wherein if the random number generated by the roulette wheel on its further subsequent spin matches the number selected with the third winning event token, a fourth winning event is defined and the player then wins at least a further portion of the prize pool.

The processor of the prize pool server suitably calculates different portions of the prize pool. For example, the processor may calculate a first portion of the prize pool, wherein the first portion of the prize pool is awarded in the event of a second winning event. Optionally, the processor of the prize pool further calculates a second portion of the prize pool, wherein the second portion of the prize pool is awarded in the event of a third winning event. Further optionally, the processor of the prize pool further calculates a third portion of the prize pool, wherein the third portion of the prize pool is awarded in the event of a fourth winning event. The first, second and third portions of the prize pool may be calculated based on the wagers received by the wager receiver and the preceding values of each of the potions of the prize pool. Accordingly, the monetary value of the losing wagers may be allocated to the separate portions of the prize pool via a pre-determined algorithm. Thus, the processor may include an algorithm via which the portions of the prize pool may be calculated.

The wager receiver is suitably a mechanism via which a player may place a bet. This may be physically, wherein the wager receiver may be an area marked on a physical table or a chip receiver which receives physical chips from a player; or it may be virtual, where a player is able to place a bet electronically via a gaming terminal. Thus, the wager receiver may be a pre-defined area on a roulette table and/or it may be an electronic device connected to the prize pool server. In embodiments in which the wager receiver includes a pre-defined area on a roulette table, the system may further comprise a wager input component, wherein the wager input component transmits details of the wagers placed via that wager receiver to the prize pool server. For example, the wager input component may be a component via which details of the wagers are input manually by a user (e.g. a croupier) or it may be an automatic component which determines the wager placed by a player automatically and transmits the wager details to the prize pool server. For example, an automatic wager input component senses properties associated with each gambling chip and automatically transmits data relating to the chips to the prize pool server.

Thus, the wager input component may include an electronic device into which details of the wagers are entered by a user or which senses properties relating to the chips used to place wagers. The electronic device then transmits data relating to the wagers placed via the chips to the prize pool server. The electronic device may be connected to the prize pool server via a wired connection or via a wireless connection. Furthermore, the electronic device may be touchscreen device.

In embodiments in which a player is playing via an electronic gaming terminal (EGT), the wager receiver may be a virtual component of the EGT, wherein the player may select an option to place one or more wagers on the progressive roulette game.

Accordingly, in embodiments which include a physical wheel, the physical wheel may form part of a roulette table which includes a wager receiving area and a wager input component.

The pre-determined condition may be a pre-determined pocket of the rotating wheel. The pre-determined pocket may be fixed, i.e. it is the same selected pocket each time the wheel is spun, or it may be a dynamically selected pocket. In such embodiments, the pre-determined pocket may be selected by the prize pool server prior to the wheel being spun, or it may be selected by the or each player before the wheel is spun. Accordingly, the prize pool server may determine a randomly selected pocket prior to each spin, wherein the randomly selected pocket defines the pre-determined condition, and/or the system further includes an arrangement via which the or each player may select the pre-determined pocket associated with their wager.

The first aspect of the invention may form a part of a networked gaming system. Thus, according to a second aspect of the invention, there is provided a networked gaming system, wherein the networked system includes a plurality of linked roulette wheels, wherein each roulette wheel has associated with it a corresponding wager receiver and plurality of first winning event tokens; and the networked system further includes a common prize pool server, wherein the roulette wheels are as defined in the first aspect of the invention; wherein if the random number generated by each roulette wheel does not satisfy a pre-determined condition a losing event is defined by that roulette wheel and the monetary value of the wagers placed by the player(s) in connection with that wheel are added to the prize pool; and if the random number generated at a table satisfies the pre-determined condition then a winning event is defined and the or each winning player in connection with that roulette wheel (the “winning event wheel”) receives one of the first winning event tokens which is used to select a number from an array of numbers that correspond to the numbers of the rotating wheel for a subsequent spin of that roulette wheel (the “winning event wheel”), wherein if the random number generated by the roulette wheel on its subsequent spin matches the selected number, a second winning event is defined and the player then wins a portion of the prize pool.

The winning event tokens, processor, wager receiver and pre-determined condition disclosed in connection with the first aspect of the invention apply equally to the second aspect of the invention.

The skilled person will appreciate that the wager receiver for each of the networked roulette wheel is connected to the prize pool server. Each such connection may be a wired connection or a wireless connection.

Additionally or alternatively, the first aspect of the invention may form part of a networked gaming system which includes one or more electronic gaming terminals (EGTs). Accordingly, a third aspect of the invention provides a networked gaming system wherein the networked system includes a master physical roulette wheel; one or more electronic gaming terminals (EGTs); and a common prize pool server, wherein the master roulette wheel includes a rotating wheel and a ball which generates a random number; wherein each of the electronic gaming terminals includes a wager receiver which receives data relating to wagers placed by a respective player; a data input which receives data relating to the random number generated by the physical table; a data output which transmits data relating to the wagers placed by a user to the prize pool server; and a plurality of electronic (virtual) first winning tokens; wherein if the random number generated by the master physical roulette wheel does not satisfy a pre-determined condition a losing event is defined and the monetary value of the wagers placed by the player(s) at each of the EGTs is added to the prize pool; and if the random number generated by the master physical roulette wheel satisfies a pre-determined condition then a winning event is defined and the or each winning player at one or more of the EGTs receives one of the first winning event tokens which is used to select a number from an array of numbers that correspond to the numbers of the rotating wheel for a subsequent spin of the master physical roulette wheel, wherein if the random number generated by the master physical roulette wheel on its subsequent spin (winning number) matches the selected number, a second winning event is defined and the player(s) who selected the winning number then wins a pre-determined portion of the prize pool.

The skilled person will appreciate that in the context of the present invention, an EGT includes a software application on processing hardware, including, but not limited to a free-standing terminal, a computer (including both desktop computers and laptop computers), a tablet computer, and a smart phone. Thus, the term “EGT” includes devices connected to a gaming server via the internet.

The master physical roulette wheel may be an isolated physical wheel wherein there are no players associated with the master physical wheel or it may be associated with a roulette table wherein one or more players may be associated with the master physical roulette wheel. In such embodiments, the physical wheel may form part of a roulette table which includes a wager receiving area and a wager input component, wherein the wager input component transmits details of the wagers placed to the prize pool server.

For example, the wager input component may be a component via which details of the wagers are input manually by a user (e.g. a croupier) or it may be an automatic component which determines the wager placed by a player automatically and transmits the wager details to the prize pool server.

Thus, the wager input component may include an electronic device into which details of the wagers are entered by a user. The electronic device then transmits data relating to the input wager details to the prize pool server. The electronic device may be connected to the prize pool server via a wired connection or via a wireless connection. Furthermore, the electronic device may be touchscreen device.

It will be understood that the networked gaming system of the third aspect of the invention may comprise more than one physical roulette wheel and at least one EGT. However, for the purposes of the EGTs, one of the physical wheels will be identified as the master physical roulette wheel. It is the identified master physical roulette wheel that generates the random number for each of the EGTs.

According to a fourth aspect of the invention, there is provided a gaming system comprising a roulette wheel including a rotating wheel and a ball which generates a first random number; a computer controlled random number generator which generates a second random number based on the first random number and a state associated with the roulette wheel; a wager receiver to receive wagers placed by one or more players; and a prize pool server, wherein the prize pool server includes a data input interface to receive details of the wagers placed by the players, a processor for determining a prize pool and a data storage module for storing data relating to the prize pool; wherein if the first and second random numbers both satisfy a pre-determined condition then a winning event is defined and at least a portion of the prize pool is shared between one or more of the players; and if at least one of the first and second random numbers does not satisfy the pre-determined condition the monetary value of the wagers placed by the players is added to the prize pool.

The skilled person will appreciate that the roulette wheel comprises a standard roulette wheel that includes a rotating wheel having a plurality of numbered pockets located circumferentially around its periphery and a ball that eventually lands in one of the pockets as the speed of rotation of the wheel slows down. Such roulette wheels are well known. The number associated with the pocket in which the ball comes to rest is a randomly generated number from the set of numbers defined by the pockets of the wheel.

In the present invention, a second random number is generated which is based on the first random number generated by the ball landing in a respective one of the pockets and a physical property of the roulette wheel.

If both the first and second random numbers generated by a spin of the roulette wheel satisfy a pre-determined condition, such as for example, both random numbers are a specific number, then a winning event is defined and one or more of the players who are playing at that time (winning players) win the prize pool or a share of the prize pool. However, if a winning event is not generated (i.e. if the first and second random numbers do not satisfy the pre-determined condition), then the monetary value of the wagers placed via the wager receiver is added to the prize pool.

Similarly, if a no winning event is defined, then the spin of the wheel generates a losing event, which results in the prize pool increasing by the monetary value of the losing wagers.

The skilled person will appreciate that the term “the wagers are added to the prize pool” refers to the monetary value of the (losing) wagers that were placed being added to the prize pool.

It will be appreciated that the progressive jackpot gambling system may exist alongside a traditional game of roulette. In other words, players may still place bets on the first random number generated by the ball landing in a specific numbered pocket of the wheel, in addition to placing wagers via the wager receiver for the progressive gambling system of the present invention. Thus, a roulette table may be provided upon which players may place their bets and the wager receiver of the present invention may be defined by a pre-determined area of the roulette table.

In an embodiment of the fourth aspect of the invention, the computer controlled random number generator includes a first array of numbers which correspond to the numbers of the roulette wheel, and a second array of numbers which correspond to the numbers of the roulette wheel, wherein the first array of numbers moves in a continuous loop in a first direction; the second array of numbers are arranged to be adjacent to the first array of numbers; and the second array of numbers moves in a continuous loop in a second direction until the state associated with the roulette wheel is achieved.

The computer controlled random number generator suitably includes a display that displays the first and second arrays of the numbers and their respective motions.

The different motion of the arrays of numbers until the state associated with the roulette wheel is achieved means that the second number is randomly generated based on a physical parameter.

In this embodiment, the first array of numbers in the loop has the same order as the numbers appear on the rotating wheel. In this way, the continuous loop of the first array of numbers corresponds exactly to the rotating numbers on the wheel. The first array of numbers may move in the first direction at a constant speed or the speed of movement of the first array of numbers may correspond to the angular velocity of the rotating wheel. Similarly, the second array of numbers in the loop may have the same order as the numbers appear on the first array of numbers and the rotating wheel.

The speed of movement of the second array of numbers may be the same as the speed of movement of the first array of numbers or it may be different.

In a further embodiment of the invention, the first array of numbers is arranged in a linear array and moves in a first direction; and the second array of numbers is arranged in a linear array which is located adjacent to the first linear array and which moves in an opposite direction until the state associated with the roulette wheel is achieved. In other words, each of the first and second arrays of numbers moves in a continuous linear array, much like a “ticker-tape” display. Alternatively, the first array of numbers may be arranged in a circular array and may move in a first sense (e.g. a clockwise rotation or an anti-clockwise rotation); and the second array of numbers may be arranged in a circular array which is located adjacent to and concentric with the first linear array and which may move in an opposite sense until the state associated with the roulette wheel is achieved.

In a yet further embodiment of the invention, the first and second arrays of numbers move in a continuous loop in different directions until the pre-determined state associated with the roulette wheel is achieved, at which point the first and second arrays of numbers are locked together with each number of the second array of numbers being aligned with a corresponding number of the first array of numbers; the numbered pocket in which the roulette ball lands defines the first random number and defines a first number from the first array of numbers; and the second random number is defined as the number of the second array of numbers which is aligned with the first number from the first array of numbers.

Accordingly, the first and second arrays of numbers of the computer controlled random number generator move in different directions until such time as a pre-determined state, such as a physical property of the roulette wheel, is obtained, at which point, the first and second arrays of numbers are locked together. In this way, the second random number is generated by the combination of the first random number and the pre-determined state associated with the roulette wheel, rather than by a computer algorithm.

According to the fourth aspect of the invention, the pre-determined state may be a pre-determined time based on the rotating wheel and/or ball or some other measurable physical property of the ball or the rotating wheel, such as its speed or distance travelled. For example, the pre-determined state may be the distance travelled by the ball or a point on the rotating wheel, which is variable as the ball is released with a different velocity and “spin” each time the wheel is spun and the rotating wheel is rotated at a different speed; or the pre-determined state may be associated with the speed of the ball or the rotating wheel, for example, when the speed of the ball or the wheel slows to a pre-determined speed. In such embodiments, the roulette wheel may include sensors that sense the distance travelled by the ball or a point on the rotating wheel, and/or that sense the speed of the ball relative to the wheel or the speed of the wheel.

In an embodiment of the invention, the state associated with the roulette wheel is a state associated with the ball of the roulette wheel, for example a pre-determined speed of the ball, optionally relative to the rotating wheel, and the roulette wheel includes one or more sensors that sense the speed of the ball.

As the odds of the first and second random numbers satisfying a predetermined condition, such as each being a specific number e.g. both being 0, are about 1 in 1369 (assuming the numbers 0 to 36 on the rotating wheel), the prize pool may become relatively large quite quickly. As such, it may be possible to split the prize pool. For example, the prize pool may include a first prize pool portion and a second prize pool portion; wherein a winning event results in the first prize pool portion being shared between one or more of the players who are playing at the time the winning event is defined and those players then play a new game based on the first random number only for a chance to win the second prize pool portion. The first prize pool portion may be the same or different as the second prize pool portion. For example, the second prize pool portion may be greater than the first prize pool portion.

The new game (second prize pool portion game) may be based solely on the first random number. In other words, it may be based solely on a single spin of the roulette wheel, wherein if a player has selected the number associated with the pocket in which the ball lands, that player wins the second prize pool portion. If no players win the second prize pool portion, the second prize pool portion may be retained within the prize pool. For example, in the event that a winning event occurs during a game of the gaming system of the present invention, each player who won a portion of the first prize pool portion (i.e. each winning player) and who is eligible to play for the second prize pool portion may be given one or more gaming tokens with which to select respective numbers associated with the pockets on the rotating wheel.

The roulette wheel according to the fourth aspect of the invention may form part of a roulette table which includes indicia that permits players to place wagers on certain numbers, groups of numbers or properties of numbers (red/black; odd/even; etc.). The roulette table may include a wager receiving area which forms the wager receiver of the invention, wherein the monetary value of the losing wagers placed on or in the wager receiving area are added to the prize pool and winning wagers placed on or in the wager receiving area permit the player(s) who placed those wagers to win the prize pool or a share or portion thereof. The wager receiving area of the roulette table may include a sensor which senses the monetary value of wagers placed thereon or therein. Such sensors are well known in the gaming industry. In such embodiments, an event other than a winning event (i.e. a losing event) results in the monetary value of the losing wagers automatically being added to the prize pool. As noted above, the roulette table may include a wager input component. The wager input component may be as defined hereinabove.

The roulette table may further include the wager areas associated with a conventional roulette table. In such embodiments, players may play a standard game of roulette for each spin of the rotating wheel and not participate in the progressive game associated with the gaming system defined herein (the “progressive game”); players may play a standard game of roulette together with the progressive game (i.e. by also placing a wager in or on the wager receiving area of the subject game); or players may only play the progressive game (i.e. by only placing a wager in or on the wager receiving area of the subject game).

According to a fifth aspect of the invention, there is provided a networked gaming system, wherein the networked system includes a plurality of linked roulette wheels and a common prize pool server, wherein each roulette wheel including a rotating wheel and a ball which generates a first random number; a computer controlled random number generator which generates a second random number based on the first random number and a state associated with the roulette wheel; and a wager receiver to receive wagers placed by one or more players; wherein each of the roulette wheels is connected to the prize pool server; wherein the prize pool server includes a data input interface to receive details of the wagers placed by the players, a processor for determining a prize pool and a data storage module for storing data relating to the prize pool; wherein if the first and second random numbers generated by one of the roulette wheels both satisfy a pre-determined condition then a winning event is defined and at least a portion of the prize pool is shared between the players associated with that roulette wheel; and if at least one of the first and second random numbers generated by one of the roulette wheels does not satisfy the pre-determined condition a losing event is defined and the wagers (losing wagers) placed by the players associated with that roulette wheel are added to the prize pool.

In this aspect of the invention, the prize pool is common to the network of roulette wheels and any one of the roulette wheels within the network may generate a winning event for the player(s) associated with that roulette wheel.

The optional features described and defined above in connection with the roulette wheel, the computer controlled random number generator and the wager receiver of the fourth aspect of the invention each apply to the fifth aspect of the invention. Similarly, the optional features described and defined above in connection with the prize pool (e.g. the prize pool comprises a first prize pool portion and a second prize pool portion and such like) also apply equally to the fifth aspect of the invention.

Accordingly, in an embodiment of the fifth aspect of the invention, the computer controlled random number generator for each roulette wheel includes a first array of numbers which correspond to the numbers of the roulette wheel, and a second array of numbers which correspond to the numbers of the roulette wheel, wherein the first array of numbers moves in a continuous loop in a first direction; the second array of numbers are arranged to be adjacent to the first array of numbers; and the second array of numbers moves in a continuous loop in a second direction until the state associated with the roulette wheel is achieved.

In a further embodiment of the fifth aspect of the invention, (i) the first array of numbers is arranged in a linear array and moves in a first direction; and the second array of numbers is arranged in a linear array which is located adjacent to the first linear array and which moves in an opposite direction until the state associated with the roulette wheel is achieved; OR (ii) the first array of numbers is arranged in a circular array and moves in a first sense; and the second array of numbers is arranged in a circular array which is located adjacent to and concentric with the first linear array and which moves in an opposite sense until the state associated with the roulette wheel is achieved.

In a yet further embodiment of the invention, the first and second arrays of numbers move in a continuous loop in different directions until the pre-determined state associated with the roulette wheel is achieved, at which point the first and second arrays of numbers are locked together with each number of the second array of numbers being aligned with a corresponding number of the first array of numbers; the numbered pocket in which the roulette ball lands defines the first random number and defines a first number from the first array of numbers; and the second random number is defined as the number of the second array of numbers which is aligned with the first number from the first array of numbers.

Optionally, the state associated with the roulette wheel for each table may be a state associated with the ball of the roulette wheel; further optionally each table may include one or more sensors to sense the speed of the ball and the state associated with the roulette wheel may be a predetermined speed of the ball.

In an embodiment of the fifth aspect of the invention, the prize pool includes a first prize pool portion and a second prize pool portion; and wherein a winning event at one roulette wheel results in the first prize pool portion being shared between the players associated with that roulette wheel and the winning players associated with that roulette wheel play a new game based on the first random number only to win the second prize pool portion.

According to a sixth aspect of the invention, there is provided a networked gaming system wherein the networked system includes a master physical roulette wheel; one or more electronic gaming terminals (EGTs) and a common prize pool server; wherein the master roulette wheel includes a rotating wheel and a ball which generates a first random number, and a computer controlled random number generator which generates a second random number based on the first random number and a state associated with the roulette wheel; wherein each of the EGTs is connected to the common prize pool server; each of the electronic gaming terminals have an input for receiving data relating to the first random number generated by the master physical roulette wheel; each of the EGTs includes a wager receiver; each of the EGTs includes a computer controlled random number generator which processes the data relating to the first random number generated by the master roulette table and generates an associated second random number based on the first random number and a state associated with the roulette wheel of the master roulette wheel; and wherein if the first and second random numbers generated by the master roulette wheel and/or an electronic gaming terminal both satisfy a pre-determined condition then a winning event is defined and at least a portion of the prize pool is shared between the player(s) associated with the master physical roulette wheel and/or EGT; and if at least one of the first and second random numbers generated at the master physical roulette wheel and/or EGT does not satisfy the pre-determined condition then a losing event is defined and the monetary value of the wagers placed by the player(s) associated with the master roulette wheel and/or EGT that generated a losing event are added to the prize pool.

Again, the optional features described and defined above in connection with the roulette wheel, the computer controlled random number generator and the wager receiver of the fourth aspect of the invention each apply to the sixth aspect of the invention. Similarly, the optional features described and defined above in connection with the prize pool (e.g. the prize pool comprises a first prize pool portion and a second prize pool portion and such like) also apply equally to the sixth aspect of the invention.

The skilled person will appreciate that the network of the sixth aspect of the invention may include one or more physical roulette table, but each of the EGTs are suitably linked to a “master” physical roulette wheel, such that the first random number for each of the EGTs is the same as the first random number generated by the master physical roulette wheel.

It will be appreciated that the master physical roulette wheel may be an isolated wheel with no players associated with it. In other words, the master physical roulette wheel functions only to generate the first random number and a corresponding second random number. Alternatively, the master physical roulette wheel may form part of a roulette table, where the master physical roulette wheel may have players associated with it.

In an embodiment of the sixth aspect of the invention, the second random number generated by the master physical roulette wheel and by each of the EGTs is the same. Alternatively, the second random number generated by each EGT may be different to the second random number generated by the other EGTs and to the second random number generated by the master physical roulette wheel. Thus, the master physical roulette wheel and each of the EGTs may each generate different second random numbers.

For example, each of the computer controlled random number generators may include a first array of numbers which correspond to the numbers of the roulette wheel, and a second array of numbers which correspond to the numbers of the roulette wheel, wherein the first array of numbers moves in a continuous loop in a first direction; the second array of numbers are arranged to be adjacent to the first array of numbers; and the second array of numbers moves in a continuous loop in a second direction until the state associated with the roulette wheel is achieved. In such an embodiment, the starting alignment between the first array of numbers and the second array of numbers may be different. As such, when the state associated with the roulette wheel is achieved, which is the same for the master physical roulette wheel and each of the EGTs, the first and second arrays of numbers have different alignments, which in turn results in a different second random number generated by the physical roulette wheel and each of the EGTs.

In an embodiment of the invention, (i) the first array of numbers of the computer controlled random number generator is arranged in a linear array and moves in a first direction; and the second array of numbers of the computer controlled random number generator is arranged in a linear array which is located adjacent to the first linear array and which moves in an opposite direction until the state associated with the roulette wheel is achieved; OR (ii) the first array of numbers of the computer controlled random number generator is arranged in a circular array and moves in a first sense; and the second array of numbers of the computer controlled random number generator is arranged in a circular array which is located adjacent to and concentric with the first linear array and which moves in an opposite sense until the state associated with the roulette wheel is achieved.

As noted above, the first and second arrays of numbers of the physical roulette wheel and each of the EGTs suitably move in a continuous loop in different directions until the pre-determined state associated with the roulette wheel is achieved, at which point the first and second arrays of numbers of the physical table and each of the EGTs may be locked together, with each number of the second array of numbers being aligned with a corresponding number of the first array of numbers; the numbered pocket in which the roulette ball lands defines the first random number and defines a first number from the first array of numbers; and the second random number is defined as the number of the second array of numbers which is aligned with the first number from the first array of numbers. Again, the point at which the state associated with the roulette wheel is achieved is a variable event. Accordingly, the alignment of the first and second arrays of numbers is random and based on a physical criterium, which in turn generates randomly the second random number.

In embodiments in which it is desired to generate a different second random number for the master physical roulette wheel and each of the EGTs, the starting alignment for the first and second arrays of numbers for the master physical roulette and each EGT is different; the speed of movement of each of the arrays of numbers is substantially the same; and the pre-determined state of the roulette wheel is common for the master physical roulette wheel and each EGT, whereby the physical roulette wheel and each EGT generates a different second random number corresponding to the common first random number. In such embodiments, the winning event remains the same, for example, the first random number must equate to a first pre-determined number and the second random number must equate to a second pre-determined number. Accordingly, only one of the physical roulette wheel(s) and the EGTs is able to achieve a winning event in such embodiments.

As with the earlier aspects of the invention, the state associated with the roulette wheel of the physical table may be a state associated with the ball of the roulette wheel; optionally wherein the physical table further includes one or more sensors to sense the speed of the ball, and the state associated with the roulette wheel is a predetermined speed of the ball.

In an embodiment of the sixth aspect of the invention, the prize pool includes a first prize pool portion and a second prize pool portion; and wherein a winning event generated by the physical roulette wheel and/or one or more of the EGTs results in the first prize pool portion being shared between the players associated with the physical roulette wheel and/or the EGTs and the players associated with the physical roulette wheel and/or the EGTs which generated a winning event play a new game based on the first random number only to win the second prize pool portion.

Embodiments of the invention will now be described, by way of example only, with reference to the accompanying drawings in which:

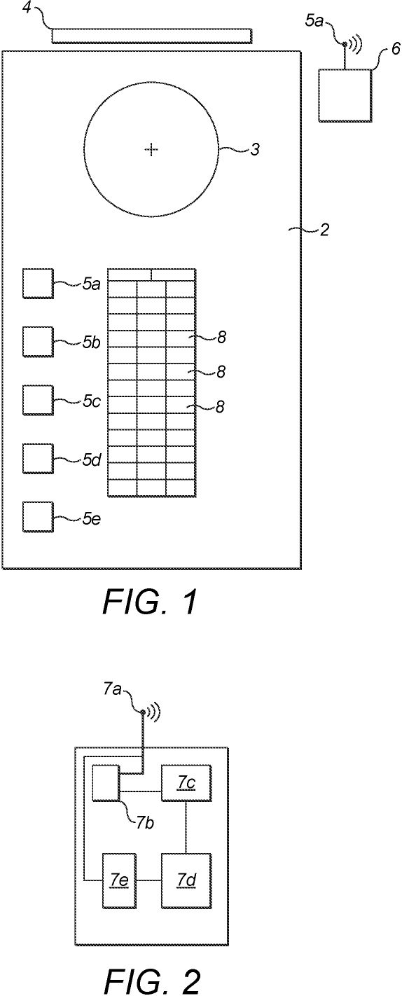

FIG. 1 is a plan view from above of a roulette table according to the first aspect of the invention;

FIG. 2 is a schematic view of a prize pool server for use with the roulette table shown in FIG. 1;

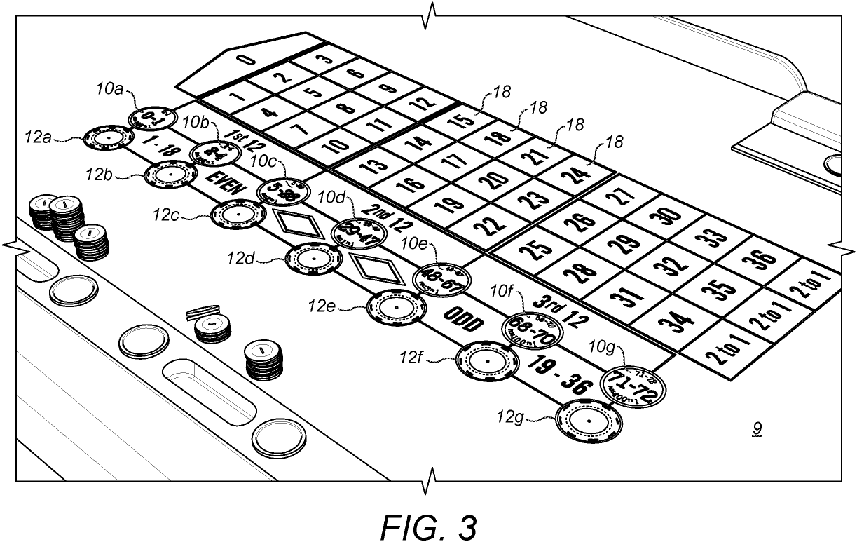

FIG. 3 is a view of part of a roulette table which forms part of the fourth aspect of the invention showing areas upon which wagers are placed; and

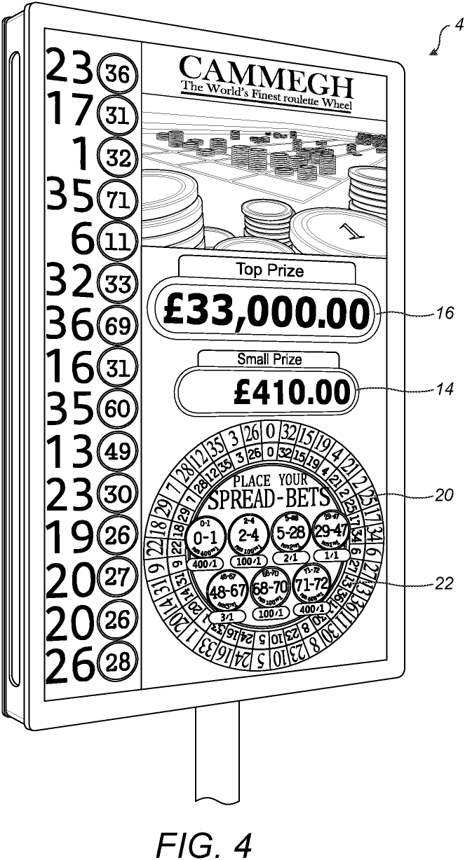

FIG. 4 is a view of a display board which forms part of the fourth aspect of the invention, showing a display based on the computer controlled random number generator.

For the avoidance of doubt, the skilled person will appreciate that in this specification, the terms “up”, “down”, “front”, “rear”, “upper”, “lower”, “width”, etc. refer to the orientation of the components as found in the example when installed for normal use as shown in the Figures.

FIG. 1 shows components of a gaming system according to the invention. The system includes a standard roulette wheel 3 comprising a rotating wheel and a ball, a roulette table 2 which receives the roulette wheel and includes a progressive wager receiver including indicia 5a-5e which indicate where wagers may be placed on the table 2 by players who wish to partake in the progressive game associated with the roulette table 2; and a wager input component 6 in the form of a touch-screen tablet device via which a user (e.g. a croupier) manually inputs bets placed on the progressive game (i.e. chips placed in the areas defined by indicia 5a-5e).

The roulette table 2 further includes a display 4 which displays current values of the progressive jackpot (which is discussed in more detail below).

The first aspect of the invention further includes a prize pool server 7 which is shown in FIG. 2. The prize pool server 7 is associated with the roulette table 2.

As noted from FIG. 1 a player is able to play one or both of two roulette-based games: the first of which is a standard game of roulette and relies simply on a random number generated by the roulette ball landing in a numbered pocket defined by the periphery of the rotating wheel; and the second of which is a progressive jackpot game, which is based on a pre-determined pocket of the rotating wheel. The pre-determined pocket is a 38^{th} pocket that includes progressive jackpot indicia; it is separate from the customary pockets numbered 0 to 36.

The standard game of roulette is well known and as such will not be discussed in detail herein.

As noted above, the table 2 includes the wager input component 6 in the form of a touch-screen tablet computer. It also includes a plurality of Bronze prize tokens (not shown); a plurality of silver prize tokens (not shown); and a plurality of gold prize tokens (not shown). These may be suitably coloured chips.

The touch-screen tablet computer 6 is wirelessly connected to the prize pool server via a wireless transmitter 6a.

The prize pool server 7 includes a wireless transceiver 7a; a data input 7b which receives data from the touch-screen tablet computer relating to the wagers placed by players associated with the table 2 via the wireless transceiver 7a; a processor 7c which determines the monetary value of the wagers placed and which allocates monetary values to a first prize pool portion, a second prize pool portion and a third prize pool portion according to an algorithm run by the processor 7c; a memory storage component 7d which stores data relating to the prize pool portions; and a data output port 7e which transmits data relating to the first, second and third prize pool portions to the display 4.

In use, the players associated with the table 2 place wagers on the progressive jackpot by placing relevant chips on one of the wager receiver areas defined by indicia 5a-5e. The croupier enters the wagers into the touch-screen tablet computer 6, which in turn transmits data relating to the wagers to the prize pool server 7.

In the event that the ball lands in a pocket other than the 38^{th} pocket, a losing event is defined for the progressive jackpot game and the progressive jackpot game continues on the next spin of the roulette wheel 3 as described above.

However, if the ball lands in the 38^{th} pocket, then a winning event is defined and all players who had placed wagers on the progressive game by placing one or more chips on the wager receiver areas 5a-5e are defined as winning players. Each of the winning players receives one or more of the bronze prize tokens, depending on the number of wagers they placed on the progressive game. The winning players place the or each of their bronze prize tokens on a selected number 8 on the roulette table 2 prior to the roulette wheel 3 being spun for a subsequent time.

If the numbered pocket on the roulette wheel 3 in which the ball lands on the subsequent spin matches the number 8 selected by one or more of the winning players and indicated by a bronze prize token, a second winning event is defined. In this case, the player who matched the random number generated by the roulette wheel 3 with their bronze prize token wins the first prize pool portion as defined by the prize pool server 7 (or a share thereof in the event of multiple winners) and obtains one of the silver prize tokens. The first prize pool portion is then re-set back to a starting value.

The winning player(s) place the or each of their silver prize tokens on a selected number 8 on the roulette table 2 prior to the roulette wheel 3 being spun for a second subsequent time.

If the numbered pocket on the roulette wheel 3 in which the ball lands on the second subsequent spin matches the number 8 selected by one or more of the winning players and indicated by a silver prize token, a third winning event is defined. In this case, the player who matched the random number generated by the roulette wheel 3 with their silver prize token wins the second prize pool portion as defined by the prize pool server 7 (or a share thereof in the event of multiple winners) and obtains one of the gold prize tokens. The second prize pool portion is then re-set back to a starting value.

The winning player then places their gold prize tokens on a selected number 8 on the roulette table 2 prior to the roulette wheel 3 being spun for a third subsequent time.

If the numbered pocket on the roulette wheel 3 in which the ball lands on the third subsequent spin matches the number selected by one or more of the winning players and indicated by a gold prize token, a fourth winning event is defined. In this case, the player who matched the random number generated by the roulette wheel 3 with their gold prize token wins the third prize pool portion as defined by the prize pool server 7 (or a share thereof in the event of multiple winners). The third prize pool portion is then re-set to a starting value.

It will be appreciated that the algorithm used by the processor 7c to calculate the prize pool portions is configured such that the second prize pool portion is greater than the first prize pool portion and the third prize pool portion is greater than the second prize pool portion.

A second embodiment of the invention is shown in FIGS. 3 and 4.

FIGS. 3 and 4 show components of a gaming system according to the invention. The system includes a standard roulette wheel (as shown in FIG. 1) comprising a rotating wheel and a ball, a roulette table 9 which receives the roulette wheel and includes indicia indicating where wagers may be placed by players (only the portion of the roulette table 9 which includes the indicia is shown in FIG. 3); a controller which includes a computer controlled random number generator; and a display board 4 (shown in FIG. 4) which is controlled by the controller.

As noted from FIG. 3 a player is able to play one or more of three roulette-based games: the first of which is a standard game of roulette and relies simply on a first random number generated by the roulette ball landing in a numbered pocket defined by the periphery of the rotating wheel; the second of which is a spread bet game based on the first random number and a second random number which is generated by the computer controlled random number generator and described in more detail below; and a progressive jackpot game, which is also based on the first and second random numbers.

The spread bet version of roulette and the alternative embodiment of a progressive jackpot version of roulette are both based on the second random number, which is generated as follows:

A computer controlled random number generator includes two concentric rings, wherein the outer ring 20 corresponds to the rotating wheel. Thus, the outer ring 20 includes a number of numbered segments which corresponds exactly with the numbered pockets of the rotating wheel. The inner ring 22 also comprises numbered segments which include the same set of numbers in the same order as the outer ring 20 and the numbered pockets of the rotating wheel. Thus, each of the rings 20, 22 defines a plurality of numbered segments which correspond to the numbered pockets of the rotating wheel.

Before the rotating wheel is rotated by the croupier, the numbered segments of the inner ring 22 are aligned with the numbered segments of the outer ring 20, such that each number of the inner ring 22 is the same as the adjacent number on the outer ring 20. This is the configuration shown in FIG. 4.

When the rotating wheel is rotated by the croupier, the outer ring 20 rotates in a clockwise sense and the inner ring 22 rotates in an anti-clockwise sense. The inner and outer rings 20, 22 spin at the same speed and this is controlled by the controller.

The croupier then introduces the roulette ball to the rotating wheel in the normal way. The roulette wheel includes a sensor which senses the speed of the roulette ball. When the speed of the ball drops to a pre-determined speed, such as, for example 40 rpm, the controller locks together the inner and outer rings 20, 22 and they stop rotating. The inner and outer rings 20, 22 are locked together in such a way that each of the numbered segments of the inner ring 22 aligns exactly with a corresponding numbered segment of the outer ring 20.

The skilled person will appreciate that the point at which the inner and outer rings 20, 22 are locked together is controlled by a physical state of the roulette wheel, namely the speed of the ball equalling 40 rpm (or any other measurable and variable physical property of the roulette wheel). Thus, the point at which the inner and outer rings 20, 22 are locked together is determined by a physical property and not a computer algorithm.

The ball will land in one of the numbered pockets defined by the rotating wheel. This is indicated on the outer ring 20 of the display 4 and constitutes the first random number. The second random number is the number of the adjacent numbered segment of the inner ring 22.

For the spread bet game, the first random number and the second random number are added together to obtain a summed value. Players are able to place bets on pre-defined ranges of the summed value with the corresponding odds. The spread betting portions of the roulette table 2 are indicated by the reference numerals 10a-10g. The odds of each group may be as follows:

| Summed value is in the range | Odds |
|---|---|
| 0-1 | 400-1 |
| 2-4 | 100-1 |
| 5-28 | 2-1 |
| 29-47 | 1-1 |
| 48-67 | 3-1 |
| 68-70 | 100-1 |
| 71-72 | 400-1 |

For the progressive jackpot game, a winning event is defined as both the first and second random numbers being 0. All other combinations of numbers are defined as losing events.

In order to play the progressive jackpot game, one or more players place one or more gaming tokens on one of the progressive jackpot wager areas 12a-12g. Each of these wager areas 12a-12g includes a sensor that senses a monetary value associated with the gaming token(s) placed thereon. Once the rotating wheel is rotated by the croupier, the controller transmits data relating to the monetary value of the gaming tokens placed on the progressive jackpot wager areas 12a-12g to a prize pool defined by the prize pool server 7 described above. If no winning event occurs, the value of the prize pool remains the same until the next game, wherein the monetary value of the subsequent progressive jackpot wagers is added to the prize pool and so on.

As noted in FIG. 4, the prize pool in this embodiment is split into a first (minor) prize pool portion, which is indicated on the display by reference numeral 14 and a second (major) prize pool portion, which is indicated on the display by the reference numeral 16. A pre-determined portion of the monetary value of each losing wager is added to the first prize pool portion and a pre-determined portion of the monetary value of each losing wager is added to the second prize pool portion by the processor 7c in accordance with the software run by the processor 7c.

In the event of a winning event occurring (i.e. both the first and second random numbers are 0), all of the players who placed a gaming token on one or more of the progressive jackpot wager areas 12a-12g are defined as winning players and the winning players share the first (minor) prize pool. In addition, the or each winning player obtains a major prize gaming token, which they then place on one of the individual numbers 18 of the roulette table 9. If the ball lands in the numbered pocket associated with one of the selected individual numbers 18 (a winning first random number) on the next spin of the roulette wheel, the or each winning player that selected the winning first random number also wins the second (major) prize pool.

If the second (major) prize pool is not won, its monetary value continues to increase as described above.

The skilled person will appreciate that the embodiments described above relate to a single table. However, the progressive jackpot game may be networked across two or more physical tables to form a networked gambling system. In such embodiments, the gambling system includes a common prize pool server 7 which is connected via a secure wired or wireless data connection to each of the table controllers. In this embodiment, each table generates its own respective first and second random numbers as described above. However, each table controller transmits data relating to the monetary value of the losing wagers placed on the respective progressive jackpot wager areas 12a-12g to the prize pool server 7, which distributes the monetary value of the wagers placed at all of the networked tables between the relevant prize pool portions.

The skilled person will also appreciate that one or more of the tables of the networked gaming system may be replaced by an electronic gaming terminal (EGT), provided that a master physical roulette wheel forms part of the network. In this embodiment, the random number generated by the master physical roulette wheel is transmitted to each of the EGTs. Accordingly, the EGTs use the random number generated by the master physical roulette wheel and do not generate their own random number.

In embodiments in which the EGTs run the spread bet/progressive jackpot games described above in connection with FIGS. 3 and 4, the physical state of the master physical roulette wheel at which the first and second rings 20, 22 are locked together is the same physical state that is used by each of the EGTs to lock together their first and second arrays of numbers.

It will be appreciated that if the first and second rings 20, 22 of numbers for the master physical roulette wheel and each EGT start with the same alignments of numbers and rotate at the same speed, the first and second random number of each of the EGTs will be the same as the first and second random numbers generated by the master physical roulette wheel. However, if it is desired that each EGT generates a different second random number to each other and the master physical roulette wheel, then the first and second rings simply need to rotate at different speeds and/or start with different alignments of the numbers of the first and second rings 20, 22.

1. A gaming system comprising a roulette wheel including a rotating wheel and a ball which generates a random number; one or more wager receiver to receive wagers placed by one or more players; a plurality of first winning event tokens; and a prize pool server, wherein the prize pool server includes a data receiver to receive details of the wagers placed by the players via the or each wager receiver, a processor for determining a prize pool and a data storage module for storing data relating to the prize pool; wherein if the random number generated by the roulette wheel does not satisfy a pre-determined condition a losing event is defined and the monetary value of the wagers placed by the player(s) are added to the prize pool; and if the random number satisfies the pre-determined condition then a winning event is defined and the or each winning player receives one of the first winning event tokens which is used to select a number from an array of numbers that correspond to the numbers of the rotating wheel for a subsequent spin of the roulette wheel, wherein if the random number generated by the roulette wheel on its subsequent spin matches the selected number, a second winning event is defined and the player then wins a portion of the prize pool.

2. A gaming system according to claim 1, wherein the gaming system further includes one or more second winning event tokens, wherein in the event of a second winning event, the or each winning player receives a second winning event token which is used to select a number from an array of numbers that correspond to the numbers of the rotating wheel for a further subsequent spin of the roulette wheel, wherein if the random number generated by the roulette wheel on its further subsequent spin matches the number selected with the second winning event token, a third winning event is defined and the player then wins at least a further portion of the prize pool.

3. A gaming system according to claim 2, wherein the gaming system further includes one or more third winning event tokens, wherein in the event of a third winning event, the or each player receives a third winning event token which is used to select a number from an array of numbers that correspond to the numbers of the rotating wheel for a further subsequent spin of the roulette wheel, wherein if the random number generated by the roulette wheel on its further subsequent spin matches the number selected with the third winning event token, a fourth winning event is defined and the player then wins at least a further portion of the prize pool.

4. A gaming system according to claim 1, wherein the processor of the prize pool server determines a first portion of the prize pool, a second portion of the prize pool and, optionally, a third portion of the prize pool.

5. A gaming system according to claim 4, wherein the second portion of the prize pool is greater in value than the first portion of the prize pool, and optionally, the third portion of the prize pool is greater in value that the second portion of the prize pool.

6. A gaming system according to claim 1, wherein the or each wager receiver includes a wager input component, wherein the wager input component is connected to the data receiver of the prize pool server and transmits details of the wagers placed via the respective wager receiver to the data receiver of the prize pool server.

7. A gaming system according to claim 6, wherein the wager input component includes an electronic device into which details of the wagers are entered by a user or which senses one or more properties relating to a chip used to place wagers.

8. A gaming system according to claim 1, wherein the rotating wheel defines a plurality of pockets around a peripheral edge portion thereof, and the pre-determined condition is a pre-determined pocket of the rotating wheel.

9. A gaming system according to claim 1, wherein the system further includes a display which displays the monetary value of the or each portion of the prize pool.

10. A networked gaming system, wherein the networked system includes a plurality of roulette wheels, wherein each roulette wheel has associated with it one or more corresponding wager receivers and plurality of first winning event tokens; and the networked system further includes a common prize pool server, wherein the prize pool server includes a data receiver to receive details of the wagers placed by the players via each wager receiver, a processor for determining a prize pool and a data storage module for storing data relating to the prize pool; wherein the roulette wheels are as defined in claim 1; wherein if the random number generated by each roulette wheel does not satisfy a pre-determined condition a losing event is defined by that roulette wheel and the monetary value of the wagers placed by the player(s) in connection with that wheel are added to the prize pool; and if the random number generated at a table satisfies the pre-determined condition then a winning event is defined and the or each winning player in connection with the roulette wheel that generated the winning event receives one of the first winning event tokens which is used to select a number from an array of numbers that correspond to the numbers of the rotating wheel for a subsequent spin of that roulette wheel that generated the winning event, wherein if the random number generated by the roulette wheel on its subsequent spin matches the selected number, a second winning event is defined and the player then wins a portion of the prize pool.

11. A networked gaming system according to claim 10, wherein each wager receiver includes a wager input component, wherein the wager input component is connected to the data receiver of the prize pool server and transmits details of the wagers placed via the respective wager receiver to the data receiver of the prize pool server.

12. A networked gaming system according to claim 10, wherein each of the linked roulette wheels has associated with it a display which displays the monetary value of the or each portion of the prize pool.

13. A networked gaming system wherein the networked system includes a master physical roulette wheel; one or more electronic gaming terminals (EGTs), wherein each EGT includes a respective wager receiver which receives data relating to wagers placed by a respective player; and a common prize pool server, wherein the prize pool server includes a data receiver to receive details of the wagers placed by the players via the respective wager receiver, a processor for determining a prize pool and a data storage module for storing data relating to the prize pool; wherein the master roulette wheel includes a rotating wheel and a ball which generates a random number; wherein each of the electronic gaming terminals includes a data input which receives data relating to the random number generated by the physical table; wherein each of the electronic gaming terminals includes a data output which transmits data relating to the wagers placed by a user to the data receiver of the prize pool server; and wherein each of the electronic gaming terminals includes a plurality of electronic first winning tokens; wherein if the random number generated by the master physical roulette wheel does not satisfy a pre-determined condition a losing event is defined and the monetary value of the wagers placed by the player(s) at each of the EGTs is added to the prize pool; and if the random number generated by the master physical roulette wheel satisfies a pre-determined condition then a winning event is defined and the or each winning player at one or more of the EGTs receives one of the electronic first winning event tokens which is used to select a number from an array of numbers that correspond to the numbers of the rotating wheel for a subsequent spin of the master physical roulette wheel, wherein if the random number generated by the master physical roulette wheel on its subsequent spin matches the selected number, a second winning event is defined and the player(s) who selected the winning number then wins a pre-determined portion of the prize pool.

14. A networked gaming system according to claim 13, wherein each wager receiver includes a wager input component, wherein the wager input component is connected to the data receiver of the prize pool server and transmits details of the wagers placed via the respective wager receiver to the data receiver of the prize pool server.

15. A networked gaming system according to claim 13, wherein each EGT includes a display which displays the monetary value of the or each portion of the prize pool.

16. A networked gaming system according to claim 13, wherein the networked gaming system further includes one or more roulette wheels connected to the network, wherein each roulette wheel has associated with it one or more corresponding wager receivers and plurality of first winning event tokens.

17-39. (canceled)
